(19) United States
(12) Patent Application Publication
(10) Pub. No.: US 2006/0271421 A1
(43) Pub. Date: Nov. 30, 2006

(54) Computer-aided system and method for visualizing and quantifying candidate preparedness for specific job roles

(76) Inventors: Dan Steneker, Hamilton (BM); Joel Wilkinson, Cochrane (CA)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/416,935

(22) Filed: May 2, 2006

Related U.S. Application Data
(60) Provisional application No. 60/677,718, filed on May 3, 2005.

(51) Int. Cl. G06F 15/02

(52) U.S. Cl. 705/9

(57) ABSTRACT

A computer-aided Internet-based method for visualizing and quantifying the job-related attributes of job candidates, employees and career seekers and a model for visualizing and measuring the comparative fit of an individual's job-related attributes to the requirements of specific job roles. The method includes the steps of making available to the user electronic forms for capturing self-reported, manager-assessed and peer assessed job attributes, a computer adaptive skill testing platform for validating self-reported skills, computer administered personality tests and credential, background and experience validation tools. The visualization model includes the comparison of candidate job-related attributes to predetermined and preconfigured standard job role requirements and dynamic customized job orders which are created by career experts and employers who have access to electronic forms for setting the desired job-related attributes and the relative weighting of these attributes.

### CROSS REFERENCE TO RELATED PROVISION APPLICATION

This application claims the benefit of U.S. Provisional Patent Application No. 60/677,718 filed on May 3, 2005, the disclosure of which is incorporated herein by reference in its entirety.

### BACKGROUND OF THE INVENTION

The present invention generally relates to the fields of career and professional development in addition to recruitment and human resources (“HR”) practices which focus on the evaluation, measurement and quantification of an individual's suitability for specific job roles. More specifically, the present invention relates to a system and method for simplifying this process by creating a visual representation of each individual's core job-related attributes which can then be quickly compared to the requirements of specific job roles, noting areas of candidate strength and areas or gaps where improvement may be required.

The most widely employed strategy by employers and recruiters alike for recruiting candidates to fill job openings continues to be by accepting and reviewing resumes in addition to other pieces of pertinent data. This process is extremely cumbersome as many job openings attract hundreds if not thousands of candidates. The advent of Internet job boards has greatly exacerbated this problem as job openings are displayed to greater numbers of potential candidates. In addition, it is widely recognized in the recruitment industry that a large percentage of candidates embellish or falsify their resumes with respect to work experience, current skill and knowledge proficiencies, educational background, and other related qualifications. Applicant tracking systems (“ATSs”) have been employed in an attempt to manage the large number of candidates through the recruitment, screening, interviewing and hiring process. However, while most ATSs are able to manage this process, they are unable to effectively integrate the various components required to effectively and efficiently manage, screen, validate and compare the job-related attributes of high volumes of job candidates without adding a great deal of complexity to this process.

Within companies, employees are vital corporate assets. Companies invest substantial resources to recruit, develop, motivate and retain their human capital. Employee evaluations are conducted to identify employee performance in order to make promotion and remuneration decisions, to provide employees with feedback for areas of high performance and areas in which further training may be required, and in an attempt to quantify the human intellectual capital of departments and entire organizations. HR information systems have been developed to address and manage these requirements, yet these conventional systems typically do so in complex ways using spreadsheets, bar charts and other descriptive statistical formats that present the resulting data in an abstract manner which is difficult to easily grasp. The sheer amount of data across employees in various job roles and within multiple departments of organizations is extremely difficult to quantify, simplify and present in a manner that is easily visualized and understood.

Career-seekers and career-changers are similarly challenged when searching for career opportunities for which they are well-suited. Most specifically, the challenges lie in quickly and efficiently determining and quantifying the job roles for which they are best suited based on specific job-related attributes, and the specific requirements they need to fulfill to become good-fit candidates for specific job roles in comparison to typical job requirements.

Accordingly, there exists a need for a system, method and model for simplifying and visualizing the evaluation, measurement and comparison of individuals to the requirements of specific job roles which overcome the disadvantages of conventional systems and methods. The job fit visualization method, system and model for visualizing the evaluation, measurement and comparison of individuals to the requirements of specific job roles and job orders in accordance with embodiments of the present invention as discussed in greater detail hereinafter overcomes the shortcomings of the prior art in this field.

### SUMMARY OF THE INVENTION

Generally speaking, a computer-aided, preferably Internet-based, method and system for visualizing, measuring and quantifying the job-related attributes of job candidates, employees and career seekers is provided.

In accordance with embodiments of the present invention, electronic forms are made available to a user for inputting self-reported job attributes, computer adaptive testing (“CAT”) skill tests for measuring and validating one's current skill and knowledge proficiencies, and computer administered personality tests for establishing one's key work-related personality traits. Similar electronic forms can also be configured to capture manager and peer assessed ratings of a user's job attributes. The self, manager and peer reported job attributes include allowing individuals to assess, for example, a user's (i) current skill and knowledge levels across over 2,000 job-related skill and knowledge categories, (ii) general level of educational attainment, (iii) specific degrees and certifications achieved, (iv) professional designations awarded, (v) years of experience in specific job roles and specific industries, and (vi) job-related personality trait preferences. The CAT skill, knowledge and computer-administered personality tests are made available to individuals to measure and validate the self-reported skills, knowledge and personality traits.

According to another embodiment of the present invention, a second electronic form is used to construct typical job profiles for more than 1000 job roles based on current labor market data and research with subject matter experts, industry specialists, HR consultants and career development experts. These typical job profiles span over 40 industry areas and are developed to exemplify the standard skills, knowledge, educational levels, specific educational and professional designations, typical personality trait characteristics and typical levels of job and industry experience each job role generally requires.

The data collected on each individual are then aggregated into a visual representation and comparative measurement of an individual's job-related attributes by comparing the individual's data to the standard job requirements of any of the more than 1000 typical job profiles. It should be appreciated that the information conveyed through the visual representation or “chart” is presented in such a manner so that each aspect of the chart, including the categories and each individual attribute, is presented in quantifiable proportion to the job role requirements and to other candidates' qualifications enabling efficient and accurate comparisons between candidates. In addition, a preferred embodiment of the job fit visualization according to the present invention employs interactive visual programming allowing for the viewer to drill-down for more detailed data and comparisons by qualification category or by individual job attribute simply by selecting (e.g., by pointing and clicking the user's computer mouse or other pointing device) the various areas of the chart.

In a similar fashion to the creation of the more than 1000 standard job roles, custom job orders can be created by employers and recruiters using the second electronic form process via modifying the requirements of any one of the standard job profiles. This custom job order can then be dynamically and visually compared to any candidate or employee's job-related attribute profile in order to measure and visualize the comparative fit between the candidate's current job-related attributes and the custom job order requirements.

Additionally, any individual's job-related attribute profile can be dynamically compared against the entire database of standard job profiles in order to determine the highest scoring and best-fit job roles for an individual's current job-related attributes. Similarly, any standard job profile or custom job order can be dynamically compared against the database of all available candidates or employees to determine the highest scoring and best-fit candidates for the given job role. Also, any candidate, career-seeker or employee can be compared against any given job profile or job order to determine areas of strength and areas for improvement.

A further aspect of the present invention is that profiles of candidates or employees can be grouped by job role or department and the mean comparative fit can then be visualized between the group and the job profile or job order in order to provide an average measurement and visual representation of the entire group's performance in relation to the job role standard. This enables a simplified and visual quantification on a group basis of the human capital within an organization.

Furthermore, the job fit visualization method and system according to the present invention can include the capability to dynamically display training recommendations for skill and knowledge gap areas shown in the visual comparison between the individual or group job attribute profile and the job profile standards to which they are being compared. This is accomplished via the association of skill and knowledge job attributes to relevant training courses and programs within the database which are displayed as a result of the request for learning recommendations specific to one or more skill or knowledge attribute items.

The training recommendation feature of the present invention enables the development of targeted employee training programs which can be implemented along with pre and post training job fit visualization comparisons of individuals and groups to job profile standards in order to produce a quantifiable visual representation of the effectiveness of the training program for each individual, or across entire groups and departments within organizations.

Accordingly, it is a principal object of the present invention to provide a method, system and a model for visualizing, measuring and quantifying the comparative fit of an individual's job-related attributes to the requirements of specific job roles. The present invention provides the means to simplify the job fit analysis process by creating a visual representation of each individual's core job-related attributes which can then be quickly compared to the requirements of specific job roles, and to other job candidates, in a quantifiable and directly comparable manner, while noting areas of candidate strength and areas or gaps where improvement may be required.

The foregoing and other aspects, features and advantages of the invention will in part be obvious and will in part be apparent from this disclosure and accompanying drawings.

The present invention accordingly comprises the features of construction, and combination and arrangement of elements, as well as the several steps and the relation of one or more of such steps with respect to each of the others, all as exemplified in the following detailed disclosure and accompanying drawings, and the scope of the invention will be indicated in the claims.

### BRIEF DESCRIPTION OF THE DRAWINGS

For a fuller understanding of the invention, reference is had to the following description taken in connection with the accompanying drawings, in which:

FIG. 1 is a flow diagram illustrating a process for capturing data elements for creating a visual representation of an individual's core job-related attributes according to an embodiment of the present invention;

FIG. 2 is a flow diagram illustrating a process by which a standard job profile can be created within a database as the standard to which job candidates, career seekers and employee profiles can be compared in order to create a job fit visualization according to an embodiment of the present invention;

FIG. 3 is a flow diagram illustrating a process for enabling employers to create custom jobs orders to which individual job candidates and/or employers can be compared according to an embodiment of the present invention;

FIG. 4 illustrates an electronic online registration form used in accordance with an embodiment of the present invention;

FIG. 5 illustrates an electronic online form for collecting standardized individual attribute proficiency data used in accordance with an embodiment of the present invention;

FIG. 6 illustrates a graphical user interface for collecting individual job-related attribute data across multiple job categories used in accordance with an embodiment of the present invention;

FIG. 7 illustrates an electronic online form for collecting self-reported skill attribute level data used in accordance with an embodiment of the present invention;

FIG. 8 illustrates a graphical user interface for browsing and viewing the key required skills and knowledge for standard job profiles used in accordance with an embodiment of the present invention.

FIG. 9 is a screen shot of a skill certification test overview and entry screen used in accordance with an embodiment of the present invention;

FIG. 10 is a screenshot of a question from a CAT skill certification test used in accordance with an embodiment of the present invention;

FIG. 11 is a results screen/transcript of an individual's performance on a skill certification test generated in accordance with an embodiment of the present invention;

FIG. 12 illustrates an individual's self-reported and tested skill inventory in relation to typically required skills and knowledge for a standard job profile used in accordance with an embodiment of the present invention;

FIG. 13 is screenshot of graphical user interface tools used to create standard job profiles, associated attributes and designation of primary attributes in accordance with an embodiment of the present invention;

FIG. 14 illustrates a graphical user interface used for setting parameters for standard job profiles to construct job fit visualizations in accordance with an embodiment of the present invention;

FIG. 15 illustrates a graphical user interface used for setting parameters for custom job orders based on standard job profiles in accordance with an embodiment of the present invention;

FIG. 16 is a diagram illustrating visual comparisons that can be made between an individual's profile data and data for predetermined standard job roles and custom job orders including comparisons to and between group profile data in accordance with an embodiment of the present invention;

FIG. 17a illustrates the results of a process for creating a job fit visualization for a job requirement profile generated in accordance with an embodiment of the present invention;

FIG. 17b illustrates the results of a process for creating a job fit visualization for an individual profile generated in accordance with an embodiment of the present invention;

FIG. 17c illustrates the results of a process for creating a job fit visualization for an individual profile with the job requirement overlay generated in accordance with an embodiment of the present invention;

FIG. 18 illustrates process results highlighting an individual's fit for each attribute category generated in accordance with an embodiment of the present invention;

FIG. 19 illustrates how aggregating individual profiles of candidates or employees for a specific job role can be used to generate comparative norm standards including industry averages, median and top performers in accordance with an embodiment of the present invention;

FIG. 20 is a detailed columnar breakdown of individual proficiencies for each attribute compared to selected norms in accordance with an embodiment of the present invention;

FIG. 21 illustrates how roll-overs on a wedge produce a pop-up box with a description of the wedge and the individual's score in accordance with an embodiment of the present invention;

FIG. 22 illustrates personality traits rollover with summarized explanation of each trait and a depiction of the individual's score in relation to group averages and job standard in accordance with an embodiment of the present invention;

FIG. 23 illustrates how a comprehensive view of a visualization can be used to compare overall and specific job fits visually between multiple groups or individuals at one time in accordance with an embodiment of the present invention; and

FIG. 24 illustrates how an individual can quickly and easily be visually compared to hundreds of different standard job roles or custom job orders simply by browsing for a different job role in accordance with an embodiment of the present invention.

### DETAILED DESCRIPTION OF THE PREFERRED EMBODIMENTS

The method, system and model according to the present invention can be implemented using a related combination of automated interfaces and manual processes. It should be appreciated, however, that greater use of automated processing and a wider range of features with multiple executions is also contemplated by the present invention.

The system according to the present invention preferably includes the component elements and means necessary to effect and control the various process steps according to the present invention as described hereinafter. Desirably, and where appropriate, the system utilizes existing computer capabilities, both hardware and software, and electronic communications links, which operate under the control of computer software. The computer software can include sets of software objects and/or program elements collectively having the ability to execute independently in a separate thread or logical chain of process execution, while permitting the flow of data inputs therebetween. Each can be executed as a separate logical server or using a separate physical device.

Embodiments of the present invention will be described hereinafter with reference to the accompanying drawings. In the following description, well-known functions, constructions or programming concepts are not described in detail since they might obscure the present invention in unnecessary detail.

User Profile Creation:

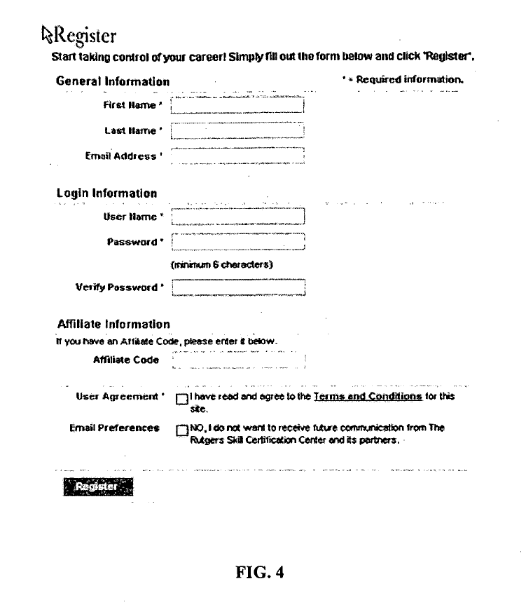

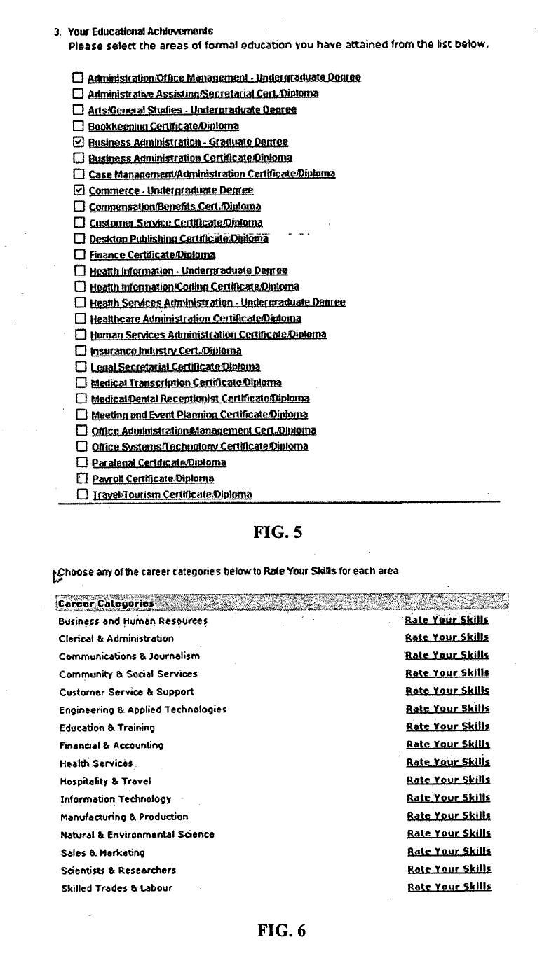

Referring now to FIG. 1 (which is a flow diagram illustrating a process for capturing data elements used to create a visual representation of an individual's core job-related attributes in accordance with one embodiment of the present invention), a job candidate, career seeker or employee engages in an online registration process in which a user profile (with, for example, user name, password, email address, first name, last name, contact information) is created and stored in a database (steps 1 and 2; see also FIG. 4). Along with the registration information, employment candidate information can also be captured and stored with the user profile.

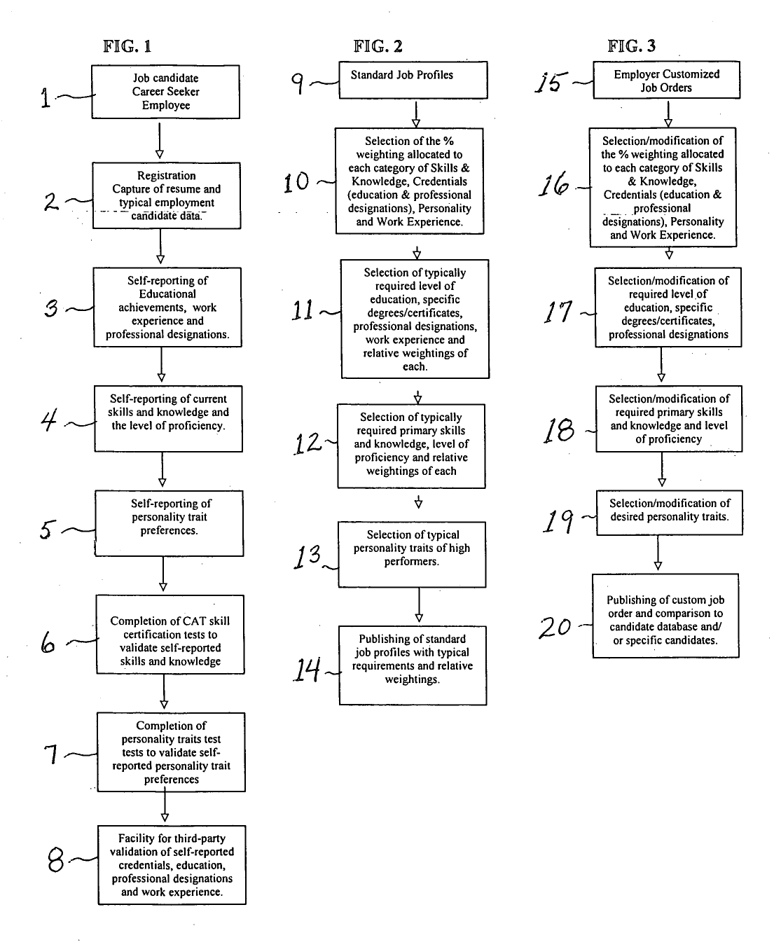

Next (step 3), users are asked to self-report on work experience data (length of experience in specific job roles and specific industries, for example), educational attainment (highest level of education achieved and specific degrees, certifications or diplomas that have been earned, for example) and professional designations earned. These items can be selected via drop-down menus from preselected database attribute elements (see FIG. 5) facilitating direct comparisons with standard job profiles (see FIG. 2) and custom job orders (see FIG. 3) which are built by selecting required items from the same standard attribute database.

The selection of work experience values can include a selection of the length of time the individual has had such experience (e.g., in years and months) while the selection of level of education, specific degrees, certificates or professional designations earned can be conducted on a binary basis via the selection of a “completed/earned” or “not earned” status. These attributes and associated numeric levels are then stored in the database with the user's profile information.

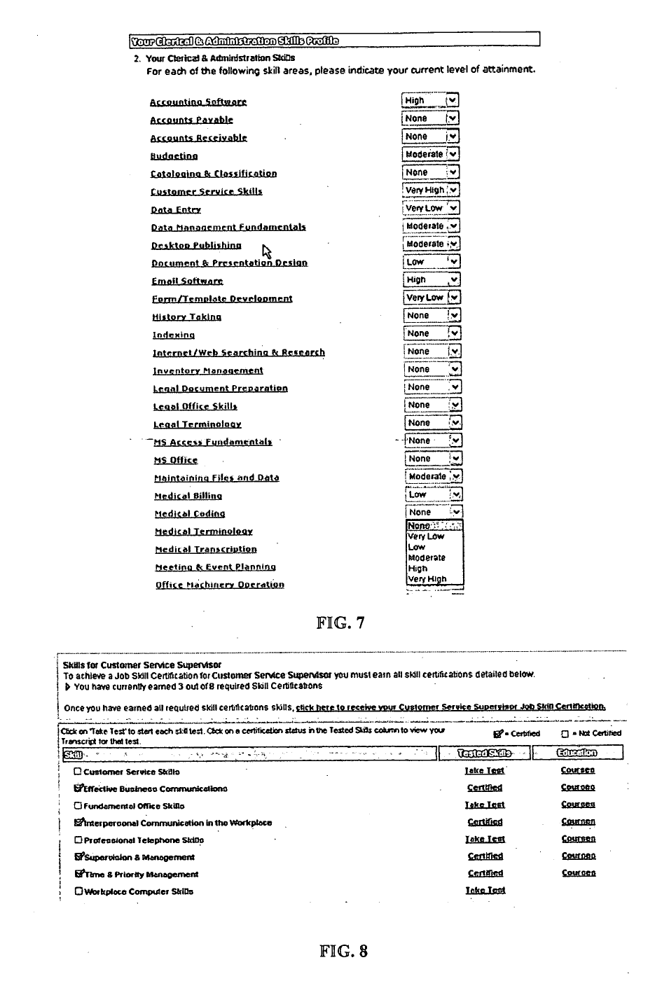

Referring back to FIG. 1, in a step 4, the job candidate, career seeker or employee is then prompted to self-report on their current work skills and knowledge via selecting these items from industry categorized electronic forms, each with preselected database attribute elements (see FIG. 6). The selection of such skill and knowledge attributes can require the selection of the individual's current level of proficiency with the skill or knowledge item. Proficiencies can be selected using a number of different scales allowing individuals to self-report on their current skill and knowledge proficiencies. One such method entails, for example, prompting individuals to choose their proficiency level between the values of “None” (no level of skill) and “Very High” (very high level of skill) using a numeric scale with values that can be chosen between 0.0 and 5.0 where 0.0 is equal to “None” and 5.0 is equal to “Very High” (the values between these two ends of the scale can be equated with each whole number as follows: 1.0=Very Low; 2.0 Low; 3.0=Moderate; 4.0=High) (see FIG. 7). The selected attributes and associated numeric levels are then stored in the database with the user's profile information.

Additionally, the chosen proficiency values can be converted to percentage scores simply by multiplying each self-selected proficiency value by a factor of 20. This percentage conversion is a preferred component of the described process for creating a job fit visualization comparison, as such values are converted to percentage scores in the process of determining the job fit scores for each attribute.

Next, referring again to FIG. 1, individuals can be prompted to self-report on various personality items (step 5). A variety of personality measures can be used for this purpose. Included in these personality items can be a self-reporting of personality trait preferences via electronic forms. One such set of personality items which can be employed asks individuals to place themselves on five continuums between polar personality trait items based on well-known and widely accepted “Big 5 Factor” personality theory applied to job roles. The five trait continuums typically used to assess work-related personality traits can be referred to as the following: (1) Stability vs. Reactivity, (2) Extraversion vs. Introversion, (3) Innovation vs. Routine, (4) Adapting vs. Challenging, and (5) Goal Focus vs. Flexibility. The ends of the foregoing five continuums can be represented by a score of +50 and −50 respectively, with the middle or balanced position between each end of the continuum being assigned a score of 0. By reflecting on the description of each position on each continuum, individuals can place themselves accordingly in any one of the following positions {−50, −25, 0, +25, +50}, thereby approximating the strength of each end of each trait continuum for their own personality. Another such personality-related measure which can be used is a measure of emotional intelligence which can ask individuals to rate their emotional competencies in the constituent emotional competency dimensions.

When individuals have self-reported on their skills, knowledge and personality items, they can be prompted to validate the skills, knowledge and personality traits that are directly related to the jobs for which they wish to be considered candidates and any other skills and knowledge for which they possess a high level of proficiency (FIG. 1, step 6). Individuals can determine which skill and knowledge items are typically required for specific jobs by browsing and viewing the display function (see FIG. 8) for the database of standard job profiles for which the required skills and knowledge have been preselected (see FIG. 2).

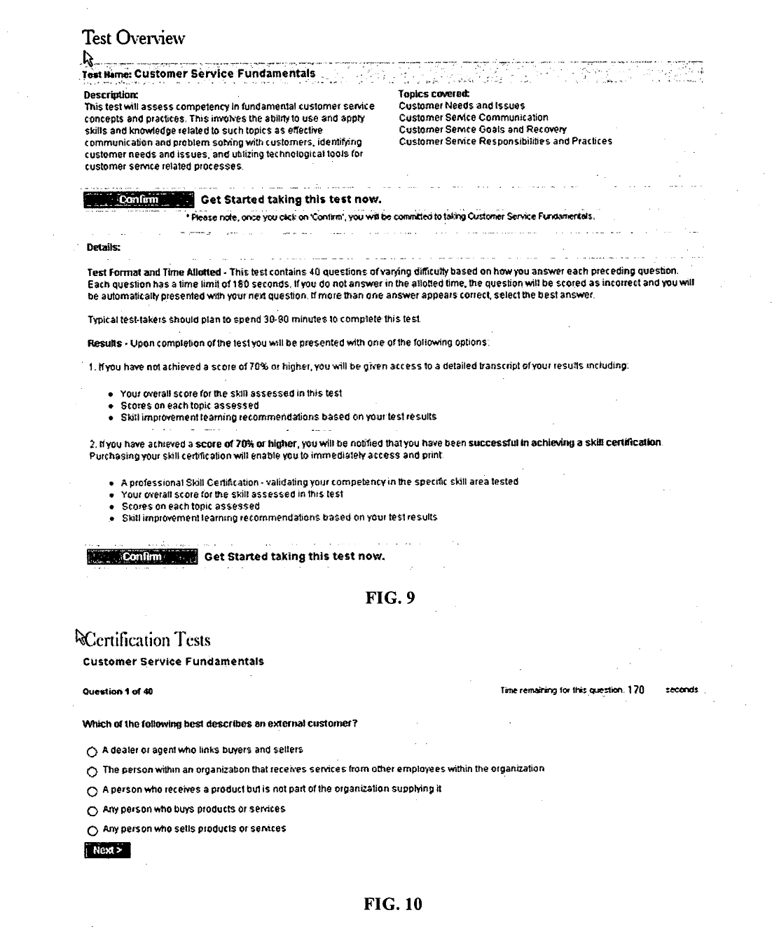

The skill and knowledge validation process can require individuals to complete skill and knowledge certification tests (see FIGS. 9 and 10). According to a preferred embodiment of the present invention, these certification tests are administered by a CAT platform which typically presents 40 questions to test takers from a pool of 130-250 questions each ranked with a level of difficulty of either one, two or three, with level three questions being the most difficult.

The CAT engine adapts to each test taker's current level of proficiency in the skill area(s) being tested by presenting questions for each test taker based on their performance on preceding test questions. In doing so, the CAT requires fewer test questions to determine a more accurate estimate of each individual's proficiency in a given skill area than can be accomplished with traditional linear tests.

A CAT scoring algorithm can be used to determine an individual's score by accounting for not only the number of questions answered correctly, but also the learning level of the questions answered correctly by considering both the number of questions answered correctly as well as the learning level associated with these correct answers. The outcome for responding correctly to a more advanced learning level question is greater than for a lower level question.

The adaptive feature of CAT tests creates a self-adjustment mechanism that continually hones in on an individual's level of ability in each test area. In addition, the CAT tests allow for testing across all topical areas related to the skill being tested.

Each individual test taker is presented with a different set of questions on a given topic. This enhances test security and allows for test retakes covering the same material but not the same questions.

CAT testing systems are widely used and typically employ many similar features—the most basic similarity being that the test employs questions of varying levels of difficulty and adapts to test takers based on how they respond to previous questions.

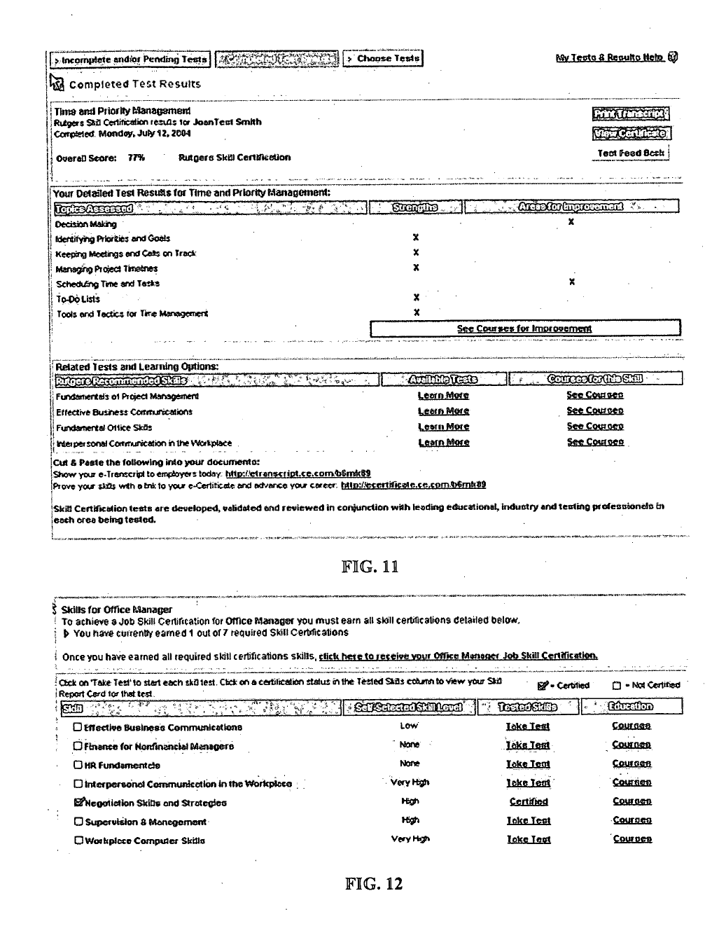

FIG. 11 depicts example results of a skill or knowledge certification test utilized in accordance with the present invention which can be reported and stored as a percentage score and can become the individual's “tested” version of the skill or knowledge item tested. The self-reported version of the same skill can become the person's subjective or “self-assessed” version of the skill or knowledge attribute (see FIG. 12). In the job fit visualization, it is the “tested” version of each attribute which takes precedence over the subjective version given its status as a “validated” attribute.

Referring back to FIG. 1, in a preferred embodiment of the present invention, amongst other possible personality measures, individuals are prompted to complete a personality trait test and/or an emotional competency test in which they are asked to respond to specific questions designed to elicit a more objective measure of where they should be placed on each trait continuum (step 7). Standard personality trait continuum questions are asked which force people to place themselves on each personality trait continuum. An example of one such question is: “I enjoy being the center of attention,” with answer options: “Very Accurate; Moderately Accurate; Neither Accurate nor Inaccurate; Moderately Inaccurate; Very Inaccurate.” Multiple questions from each end of the continuum are posed with corroborating answers and conflicting answers calculated to produce a final score for each trait. In a typical 50 question personality trait test, for example, ten questions could be posed for each trait with five questions targeting each end of the continuum. In the foregoing example question: “I enjoy being the center of attention,” a “Very Accurate” response could, for example, score +5 for the Extraversion trait while a “Very Inaccurate” response could score −5 on this continuum for the Introversion trait. Additionally, “Very Inaccurate” responses for questions targeting introversion could, for example, result in +5 scores for Extraversion.

In an example scoring for such a personality traits test, all question scores are summed and a final score can be calculated between +50 and −50 with scores falling between the five standard points on the continuum (+50, +25, 0, −25, −50) being rounded to the nearest standard value. Scores for choosing the other answer options on a per question and per trait basis can be calculated as follows: “Very Accurate” (+5); “Moderately Accurate” (+2.5); “Neither Accurate nor Inaccurate” (0); “Moderately Inaccurate” (−2.5); “Very Inaccurate” (+5).

Also, according to a preferred embodiment of the present invention, the individual profiling system is designed to allow for administrators to configure a third-party validating authority (step 8). A third party validating authority can be a manager within an organization or an agency who certifies candidate employment or educational backgrounds. When the third-party validators are configured with the required permissions within the database, they are able to create a validated status of non-testable attributes on an individual profile basis thereby “validating” or creating an objective version of such job-related attributes as educational attainment, work experience and professional designations. As with the skills and knowledge attributes, the validated or “tested” version of each attribute desirably takes precedence over the self-selected version in the job fit visualization process.

Creation of Standard Job Profiles:

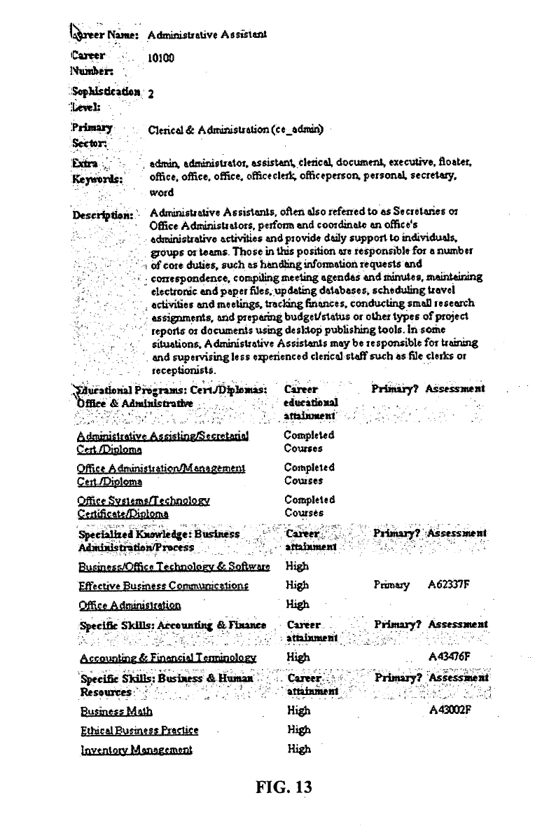

Referring now to FIG. 2 (which illustrates a process by which a standard job profile can be created within the database as the standard to which job candidates, career seekers and employee profiles can be compared in order to create a job fit visualization) electronic forms can be used by administrators to construct typical job profiles for common job roles based on current labor market data, research with subject matter experts, industry specialists, HR consultants and career development experts (step 9). These typical job profiles are developed to exemplify the standard skills, knowledge, educational levels, specific educational and professional designations, typical personality trait characteristics, and typical levels of job and industry experience each job role generally requires (step 11). Each job profile is desirably created as a distinct database element and attributes from the standard attribute database can be associated with each profile (see FIG. 13).

The attribute items associated with each job profile can be selected via drop-down menus from preselected database attribute elements facilitating direct comparisons with individual profiles and enabling efficient customization of these profiles in the creation of custom job orders (see FIG. 3). The key required skills, knowledge, education, professional designations, work experience attributes and personality trait preferences are desirably configured during this process as the “primary attributes” to which individual and group profiles can be compared (see FIG. 13).

Each attribute element selected as a “primary attribute” (step 12) is given a “job requirement level (or score)” and a “maximal level (or score)” of attainment. This “job requirement level” is the typically required amount of work experience, skill or knowledge required (the default required level for testable attributes being 70%), the typical “optimal score” for each personality trait, and typically required education or professional designations. The “maximal levels” are set as the highest levels of attainment in each attribute element after which further attainment is no longer relevant to the job role (the default maximal level for testable attributes being 100%).

According to a preferred embodiment of the present invention, the educational attainment and professional designations for each job profile are selected on the basis of whether the attribute is “Required,” “Preferred,” or not applicable via drop-down menus from preselected database attribute elements to facilitate direct comparisons with individual profiles and allow for further customization in job orders (see FIG. 3).

Personality traits for job profiles can be selected by choosing the score for the placement on each continuum which best exemplifies the typical trait profile of high performers in each specific job role while emotional competency requirements can be set based on a percentage score as with testable attributes (step 13).

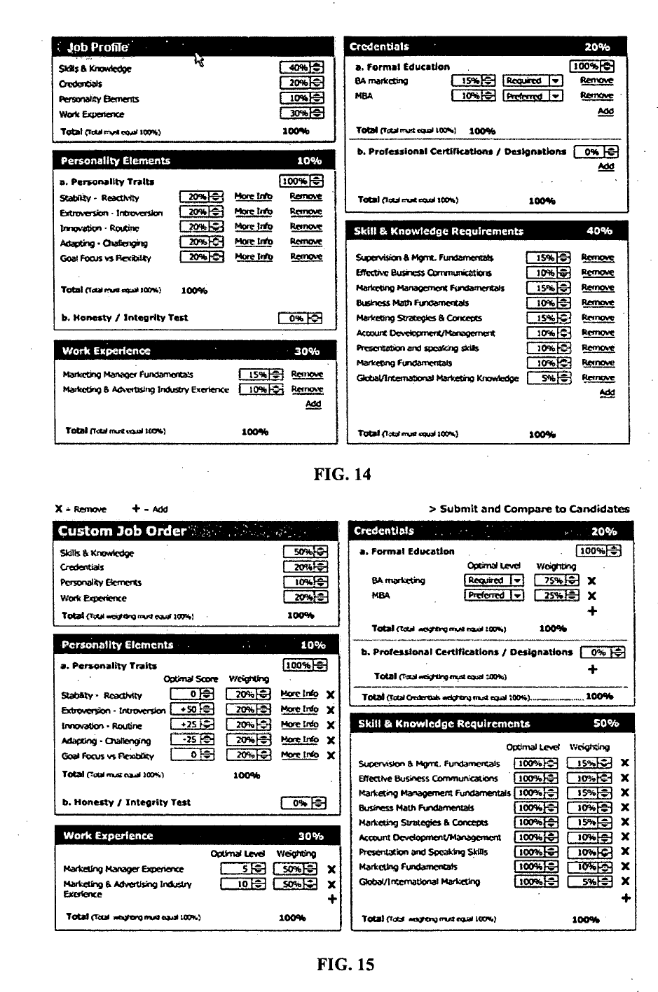

As part of the job profile creation process (FIG. 2, step 10), relative weightings can be associated with the following job fit visualization attribute categories, and fewer or more categories as required: Skills and Knowledge; Credentials (Education and Professional Designations); Work Experience; and Personality (see FIG. 14). The relative weightings for all included categories totals 100%. These weightings determine the relative importance placed on each category for the job fit visualization. If any category should not be included for a given job profile (for example, some entry level roles may typically not require work experience), then the relative weighting for that category is set to 0% and the category is excluded from the job fit visualization.

All of the associated attribute data, attribute and category weightings, and numerical proficiency levels can be stored with the job profile data in the system database. Desirably, a facility for browsing and displaying profiles and associated attributes (categorized by job/industry category) to individuals via an Internet-based interface is provided (step 14).

Creation of Custom Job Orders:

Referring now to FIG. 3, a process for creating a custom job order according to an embodiment of the present invention is provided for employers/managers who wish to create a unique job profile (or modify an existing standard job profile) in order to create a company-specific standard to which candidate and/or employee profiles can be compared. The facility to create such a custom job order (step 15) is an electronic form, which can be pre-filled with attribute data and numerical weighting and optimal level values from a standard job profile selected by the employer, and which allows for modification of the standard job profile to create a customized job order specific to the company's requirements for the specific job role (see FIG. 15).

According to a preferred embodiment of the present invention, the custom job order creator can modify the relative weightings of each of the four job fit visualization attribute categories (i.e., Skills and Knowledge; Credentials (Education and Professional Designations); Work Experience; and Personality) thereby modifying the relative importance of each category and altering the shape of a candidates' job fit visualization when compared to this custom job order vs. the standard job profile (step 16). Similarly, the relative weightings and optional levels/scores placed on each attribute within each category can be modified in addition to adding new attributes and removing relatively unimportant attributes for the specific job role (steps 17-19).

All of the associated attribute data, attribute and category weightings, optimal proficiency levels can be stored with the custom job order in the system database.

Creation of Job Fit Visualizations

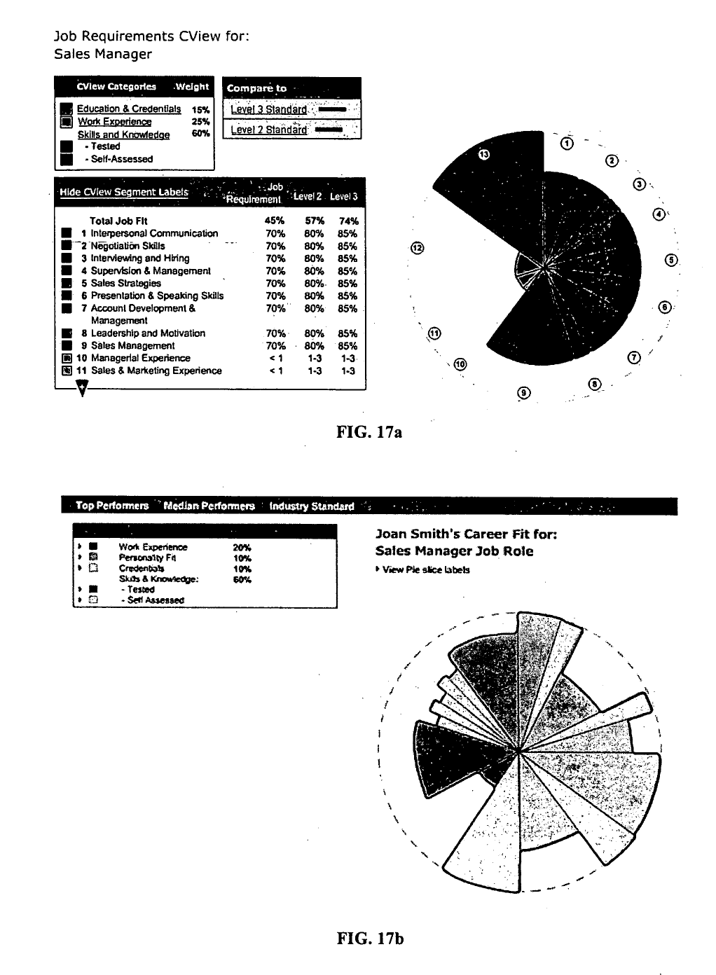

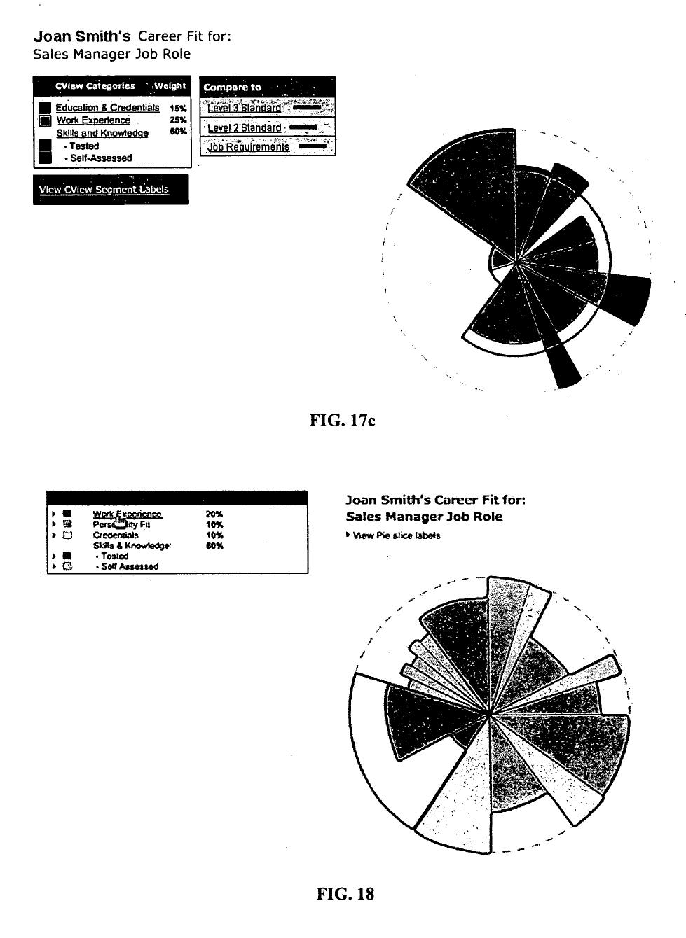

The data collected on each individual (FIG. 1) are then aggregated into a visual representation and comparative measurement of an individuals' job-related attributes by comparing the individual's data to the standard job requirements (see e.g., FIG. 2 and FIG. 17b) of any one of hundreds of standard job profiles or a custom job order (FIG. 3) that has been created to represent the requirements of a specific job role in an organization (FIG. 3, step 20). Similarly, the data defined for each specific job's requirements can be aggregated into a visual and quantifiable representation of the requirements for particular job roles (FIG. 17a).

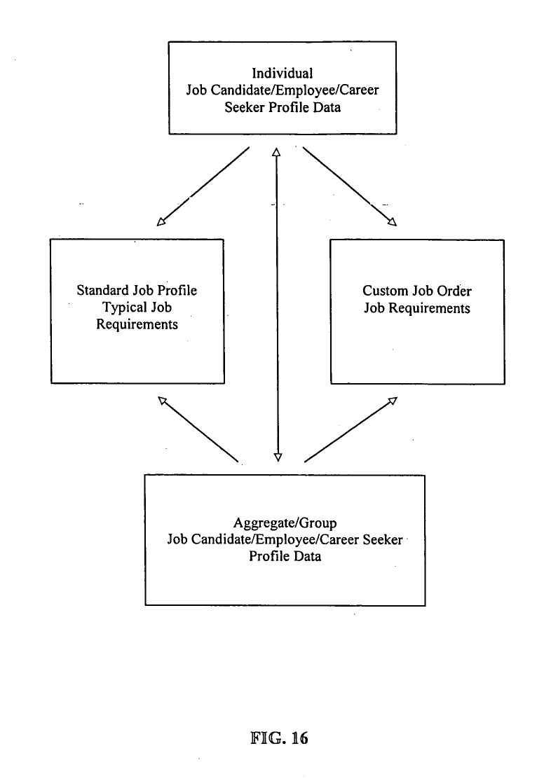

FIG. 16 illustrates the visual comparisons that can be made between an individual's profile data and the data for predetermined standard job roles and custom job orders. Additionally, the arrows indicate that an aggregation of data from multiple individual profiles can be grouped in order to make comparisons between the group average for each data point and standard job profiles or custom job orders. Also, individual data items can be compared to group averages in order to determine individual performance and job fit in relation to company-specific or industry-specific standards.

Group aggregate profiles can be constructed by averaging the data points of job candidates and career seekers in similar job roles and/or industries, departmental employees in specific organizations, employees in similar job roles, and the average scores of top, median or low performers within organizations. This enables the comparison of individuals to industry standards for particular jobs roles and employees or job candidates to the same industry standards in addition to company-specific average, median, top performer, and/or level 1, level 2, level 3, etc. standards

FIGS. 17a-c illustrate the results of the process according to the present invention of creating a job fit visualization for an individual profile. An image (preferably, circular, as depicted in FIGS. 17a-c as well as various of the other drawing figures) is created via a computer-manipulated graphical presentation of the standard job profile or custom job order data points. The algorithms and techniques used to create such an image are discussed in greater detail hereinafter. The methods described are a preferred version of a number of possible methods for achieving a similar graphical representation of an individual or group job fit in comparison to a specific job role. Because the job fit visualizations depicted in the drawing figures are constructed based on a circular geometry, geometric formulae applied to circles in conjunction with computer graphical programming logic are employed to create the resulting job fit visualization.

According to a preferred embodiment of the present invention, the individual job fit visualization comparison is accomplished via the steps discussed below (which detail the creation of the circle parameters including the algorithms for creating the category and attribute wedges and the determination of the placement of the circle perimeter for each attribute wedge shown in the visualization):

An existing standard job profile or a custom job order is first chosen as the standard to which an individual will be compared. The parameters configured for specific attributes, categories, weightings, job requirement levels and maximal levels become the underlying blueprint for the comparison and visualization of an individual's job fit.

Each circular image can be sectioned into category wedges based on the percentage allocated to each of the categories in the standard job profile or custom job order configuration process. The entire area of the circle is deemed to be equivalent to 100%, therefore each wedge occupies the configured percentage of the total area of the circle. In order to differentiate categories, each category wedge is desirably identified by a unique color, for example: Skills and Knowledge=Green; Work Experience=Red or Orange; Personality Traits=Orange or Yellow; Credentials (Education and Professional Designations)=Blue.

Within each category, individual attribute wedges can be visually defined using lines (e.g., light gray) originating from the center of the circle which detail each specific attribute associated with the job profile or custom job order standard.

The “maximal” level score defines the position of the perimeter of the circle for each specific wedge. The perimeter of the circle for each attribute wedge is set at [R=X=M] where “R” is the radius, “X” is the actual predefined radius measurement for all visualizations, and “M” is the maximal level or score assigned to each attribute wedge.

For the Skills and Knowledge category, each primary attribute can be assigned a percentage weighting which determines the size of each attribute wedge within the total area assigned to the category wedge. When attributes are configured, a “job requirement” score and a “maximal” score is set for each specific attribute item, or the default of 100% can be left as the maximal requirement.

For the Personality Traits category, each trait will receive a wedge equal in size to the percentage of the total personality trait category wedge that was been configured in the standard profile or job order process. The “job requirement” score is the score on the continuum which has been chosen as the optimal fit for the specific job standard. Job requirement scores for each trait on a custom job order default to the fit scores for the standard job profile on which the custom job order is based. These job requirement, in this case, typically are equivalent to maximal scores and therefore typically become associated with the perimeter of the circle for each trait wedge so that the closer a person fits the job requirement, the closer their visual score will be to the wedge perimeter. Other personality wedges can be added in a similar manner to measure and assess work-related attitudes and behaviors.

For the Work experience category, wedges can be defined for the job requirement and maximal levels of experience (in years) for one or both of the experience in a specific job role or the experience in a specific industry. As with the preceding categories, each wedge size can be dependent on the percentage of the category allocated to each attribute and the maximal level of experience will be associated with the perimeter of the circle for each wedge.

In the described embodiment of the invention, the credentials category can be constructed somewhat differently than the three foregoing categories. Only one wedge is assigned for Education while one or more wedges can be allocated to the job standard for required Professional Designations.

When the educational elements are configured for a standard job profile or custom job order, up to two general levels of education attributes are first selected from the list of general educational attainments which includes: High School Incomplete, High School Diploma/GED, Professional/Technical Certificate/Diploma, Associate Degree/College Diploma, Bachelors Degree, Masters Degree, Doctorate, Post-Doc. Degree. Each of these general educational elements are designated as “required” or “preferred.” Required educational attributes receive greater weight in the construction of the education wedge job fit visualization comparison.

In some cases, only general education levels will be selected, while in other cases, more narrowly defined educational attributes will be configured as detailed below.

The Highest level of education specified becomes the optimal standard to which an individual is compared. This would typically be the “preferred” item unless only a required item was configured.

Each general education level is deemed to assume or require a preceding level. This simply means that if a job profile is set to require a Masters degree, then it is also inherently deemed to require a Bachelors degree. In this way, individuals can be allocated partial scores for attributes deemed to be preceding attributes to the attributes set as required.

Following the selection of a general education attribute, educational modifiers can be selected which add greater specificity to the educational requirements. One type of educational modifier is a specific degree/diploma or certification. These specific educational attributes can be added by a dynamic selection process which utilizes a predefined database association between the general educational level and the level of the specific attribute. For example, a specific attribute of Bachelor of Commerce can be selected for the general level of Bachelor's degree. Similarly, a second specific selection may be MBA for the second general selection of Masters Degree. Each of these chosen attributes are designated as “required” or “preferred” (for example: Bachelor of Commerce—Bachelor's degree required, MBA—Masters degree preferred).

A second type of educational modifier which can be employed is the selection of an institution, organization or country from which an educational attribute was granted. For example: Harvard University can be selected as the specific granting institution for a required Bachelors degree. Also, both modifiers can be added to construct an educational requirement; for example: Bachelor of Commerce, Harvard—Bachelor's degree required, MBA, NYU—Masters degree preferred.

Each of the modifiers that are added to an educational attribute requirement create a more narrowly defined educational attribute and, in so doing, modify the job requirement level and the maximal level attainable, and therefore the definition of the perimeter of the circle for the education wedge.

Using this preferred embodiment of the invention, if a specific professional designation is selected for the standard job profile or custom job order, the designation is selected as “required” or “preferred.”

The designation attribute is selected from a specific job category (e.g., Nursing Designations).

In some cases, designations, by virtue of the process by which they are earned and applied, are deemed to assume or encompass a preceding level. For example, RN (Registered Nurse) is deemed to encompass LPN (Licensed Practical Nurse), while CCNP (Critical Care Nurse Practitioner) encompasses CCNA (Critical Care Nurse Assistant). In this way, for some designations, individuals can be allocated partial scores for attributes deemed to be preceding attributes to the attributes set as required. In such cases, attributes deemed to precede other chosen attributes can be contained within the same professional designation wedge. In such cases, the highest level designation specified becomes the maximal standard to which an individual is compared. This would typically be the “preferred” item unless only a required item was configured.

The choice of more than one professional designation in which there is no relationship between the attributes will result in multiple wedges.

Following the selection of the Professional Designation attribute(s), designation modifiers can be selected which add greater specificity to the professional designation requirements.

A designation modifier is the selection of an organization, association, institution, country or state from which the professional designations was granted. For example, New York State can be selected as the state in which a CCRN (Critical Care Nursing) designation was granted.

Each of the modifiers that are added to a professional designation attribute requirement create a more narrowly defined educational attribute and, in doing so, modify the job requirement and the maximal level score and therefore the definition of the perimeter of the circle for the professional designation wedge.

When the parameters for the perimeter of the circle and various category and attributes wedge are calculated based on the standard job profile or custom job order following the above steps, the individual profile data points can be compared to the job profile standard in order to create the individual job fit visualization. In accordance with a preferred embodiment of the present invention, the process for this comparison is effected as follows:

For each attribute wedge, the job profile score is shown as function of the distance between the job requirement score/level and the maximal level attainable. Similarly, the individual profile score is shown as a function of the distance between the individual's score/level and the maximal score/level as defined in the job profile standard or custom job order. Specifically, both the job requirement score and individual's score for each specific attribute can be represented by a colored-in portion of the wedge which visually defines the specific attribute. When only the job requirement is displayed, the job requirement scores fill in the colored portions of the wedges (FIG. 17a). However, when the individual's scores are displayed in comparison to the job requirements, the individual's scores are represented by the colored in portions of the wedges while the job requirement scores are shown using a black line overlay in order to demonstrate the comparison between the individual's score/level for each wedge and the job requirement level/score for each wedge (FIG. 17c).

The coloring of the wedge desirably originates from the center of the circle and moves outward to a point defined as the individual's score compared to the maximal score (which forms the perimeter of the circle).

Colors for self-reported attributes can be a dulled version of the primary color (e.g., light green for self-reported skills and knowledge vs. dark green for tested skills and knowledge). In addition, tested and validated attribute scores take precedence over self-reported scores and levels. As self-reported attributes are tested and/or validated, they are replaced by the tested and validated values in the default view of the individual. However, it is also possible to create controls in the viewer application which can be clicked on to show the various attribute “states” including, but not limited to, “self-reported” scores/levels, “tested” scores/levels and “validated” scores levels. There are other attribute “states” which can be configured to be captured in the database and made viewable—these include: “manager-assessed” and “peer-assessed” states.

The individual's scoring can be based on a linear, or logarithmic scaling (or other appropriate scale for visualizing the individual's score on a particular attribute compared to the job standard) of the difference between the attained score and the maximal score. A logarithmic scale can be employed to enhance the differentiation of individual scores nearer the perimeter of the circle where the individual's wedge, if the scale were linear, would rapidly consume a greater portion of the area of the job standard wedge. Scoring can also be shown in comparison to the job requirement, to average and top performers aggregate scores.

According to a preferred embodiment of the present invention, the individual's score is measured by calculating a radius as a percentage of the entire circle radius (which is deemed to be 100%). This calculated radius for each wedge is measured from the center of the circle outwardly towards the perimeter by splitting the wedge assigned to the specific attribute down the middle. The computer graphical algorithm then rounds the wedge outward from the wedge midline to the wedge borders in parallel with the curve of the perimeter.

When all wedge radii lengths are calculated, the computer graphical algorithm can be programmed to slightly round the corners of each attribute wedge to create a uniform structure. Corners of wedges with a smaller radius than those beside them can be rounded up slightly to meet the next wedge, while corners of wedges with a larger radius than those beside them are rounded down slightly to meet the next wedge. This is accomplished for visualization purposes only in order to create a uniform job fit visualization. The entire continuous outline of the individual's job fit can then be colored (e.g., black or dark grey) to create a distinct job fitness image for the individual in relation to the standard job profile or custom job order requirements.

As illustrated in FIG. 18, the individual's fit for each attribute category can be highlighted by clicking on the category legend (e.g., at the top left of the screen). When a category highlight is selected, the specific category is outlined in a dark version of the category color clearly showing both the fit and the gaps between the individuals' scores and the job profile standard.

For the Skills and Knowledge category, with each attribute's maximal score default set to 100%, the perimeter of the circle for each attribute wedge is set at [R=100%], where R is the maximal radius. The individual's score (or the job requirement score) “X” is calculated by finding the radius of the colored-in portion of the wedge which is calculated as a percentage of the maximal wedge score: [X/R×100%=wedge score] (the actual individual's score “X” divided by the maximal score converted to a percentage). If the maximal scores are modified from the default of 100% then the actual individual or job requirement score M and colored-in portion of the wedge are adjusted accordingly in comparison to the revised standard based on the formula [R=M], where “M” is the maximal score.

As noted above and for all of the following attribute category scoring sections it should be noted that a logarithmic scaling can be applied to the actual score when drawing the visualization (or another appropriate method for visualizing the individual's score) in order to more accurately represent the individual's score as a function of the area of the wedge in relation to the job standard given the increasing wedge width as the score becomes greater.

For the Personality Traits category, the perimeter of the circle for each attribute wedge is set at [R=100%] where R is the radius, which is represented by a 100% fit for the trait. The individual's score is calculated by finding the difference between the maximal score placement on the trait continuum and the actual score placement of the individual on the same trait continuum. The difference is subtracted from the 100% fit for the trait resulting in a percentage fit for the individual compared to the optimal job standard.

For the Work experience category, the perimeter of the circle for each attribute wedge is set at [R=100%] where R is the radius representing the maximal level/score and X is the individual or job requirement score. The individual's score can be calculated by converting the maximal level of experience and the actual level of experience of the individual into months, then finding the percentage of the maximal that the actual individual's experience represents. The result is a percentage fit for the individual compared to the maximal job standard [%=X/R×100].

The Credentials category can involve a greater level of complexity in determining the individual score and the subsequent wedge radius calculations.

For the Education wedge, the perimeter of the circle for each attribute wedge is set at [R=100%] where R is the radius. When only general education levels are selected, the algorithm is simplified. When the job standard is configured, general levels can be set as required or preferred. In most cases the lower level attribute will be required, while the higher level attribute will be preferred, while in some cases both levels will be set as preferred. Any other combinations are illogical and are therefore not allowed given that every general level of education assumes the preceding educational level. Since required levels receive greater weight but higher levels determine the perimeter of the wedge (the maximal standard) then scoring for general level attributes is accomplished by designating a weighted ratio, for example, between required and preferred. For example, with Bachelor's degree required, Masters degree preferred, the Masters degree becomes the maximal level but the Bachelors degree carries greater weight since it is the required item. The individual can receive a larger proportion of the educational wedge for the Bachelors degree, and, if they also have a Masters degree, they will receive a 100% score. If both attributes were “preferred” then the ratio would be much more equal with the lower level attribute always receiving a slightly higher weighting towards the completion of the wedge given that, in a practical sense, that the lower level must be completed prior to completion of the higher level. Since one typically cannot earn a Masters degree without a Bachelors degree (bachelors degree is assumed), an individual who reports earning a Masters degree for this example would receive a 100% score and a full wedge.

Each general education level can be deemed to assume or require a preceding level, meaning that individuals can be allocated partial scores for attributes deemed to be preceding attributes to the attributes set as required. For example, for Bachelor's degree required, Masters degree preferred, if the individual currently has only an Associate degree, they could receive a partial score for the “preceding” attribute which demonstrates that the individual has partially completed the job standard requirements. In this case the individual could receive no score for the Masters degree but a partial score for the preceding attribute to the Bachelors degree enabling the individual to attain a minimal partial score in relation to the job standard.

Following the selection of a general education attribute, educational modifiers can be selected which add greater specificity to the educational requirements. Educational modifiers can be a specific degree/diploma or certification or an institution, organization or country from which an educational attribute was granted.

For the purposes of calculating an individual's score, each educational modifier selected modulates the individual's score downward in comparison to the job standard, if the individual does not have the modifier specified. For example, for Bachelor's degree required—Bachelor of Commerce, Masters degree preferred, if the individual has a Bachelor of Marketing Degree, but not a Bachelor of Commerce or a Masters degree, they receive credit for the bachelor level degree modulated downward by the lack of the Bachelor of Commerce degree and the lack of the Masters degree. If a second modifier had been added to the job standard which requested the Bachelor of Commerce degree be from Harvard University and the individual did not receive their degree from this institution, then the Bachelors degree level score would be modulated further downward in relation to the job standard, thereby comprising a smaller wedge.

For the Professional Designation wedges, the perimeter of the circle for each attribute wedge is set at [R=100%], where R is the radius, which is represented by a 100% fit with the maximal value set as the job standard.

Required or preferred designations can be treated in the same manner as in the Education wedge—e.g., scoring with a ratio between required and preferred attributes which weights required attributes higher.

Designations which are deemed to encompass preceding designations are also treated in the same manner as educational attributes with partial scores awarded for preceding attribute.

Professional Designation modifiers are treated in a similar fashion to educational modifiers by modulating the individual's designation attribute downward, if individuals do not have the modifiers specified.

When all scores are calculated and the individual radii scores for each attribute have been drawn, the overall job fit score can be calculated which results in an overall “fit” score for the job candidate, employee or career seeker for the specific job role. This overall fit score can then be compared directly to other job candidates or employees for the same job role or to determine an individual's best-fit for multiple different job roles. This overall job fit visualization score can be calculated as follows:

(i) Calculation of the percentage of the total area of the circle that is covered (or filled-in) by the individual wedge scores [Ai/Ac×100=% Fit] (Area of the individual/area of the circle×100=% Fit)—such a score would be calculated by taking each individual wedge radius (as a percentage of the maximal radius), applying the area of a circle calculation (pi×Ri×Ri), finding the value of this circle as a percentage of the maximal circle area (pi×100×100), then finding the area of the individual's wedge by multiplying the above value by the percentage of the total circumference of the circle occupied by the given wedge. This final calculation must take into account the category weighting multiplied by the specific wedge weighting within the category. Once each wedge area is found, these can be summed into a total individual area score (Ai) which is then divided by the maximal area of all wedges (Ac—circle area) and multiplied by 100% to achieve a job fit score as a percentage of the maximal circle area.

(ii) Calculation of the percentage of the total circumference of the circle that is made up of the sum of the rounded perimeter segments at the end of each individual attribute wedge [SumCi/Cc×100=% Fit]—since these rounded segments become longer as the wedge score increases the resulting job fit score is proportional to the score found via calculating the percentage of the total area as detailed above. A similar calculation can be made by squaring off the wedge ends then summing these linear segments dividing by the circumference of the circle and multiplying by 100.

(iii) Calculation of the sum of all wedge radii divided by the total number of wedges multiplied by the circle radius multiplied by 100 [SumRi/nRc×100=% Fit].

(iv) The three methods noted above can be employed using the job requirement values to determine the overall job requirement score (Aj) in relation to the maximal score attainable (the maximal area of the circle—Ac).

Advanced Visualization Features:

When individual data have been gathered, group averages can be similarly visualized following the foregoing procedures in order to compare individual performance and job fit in relation to company-specific or industry-specific standards. Group aggregate profiles can be constructed by averaging the data points of job candidates and career seekers in similar job roles and/or industries, departmental employees in specific organizations, employees in similar job roles, and the average scores of top, median or low performers within organizations. This enables the comparison of individuals to industry standards for particular job roles and employees or job candidates to the same industry standards in addition to company-specific median and top performer standards.

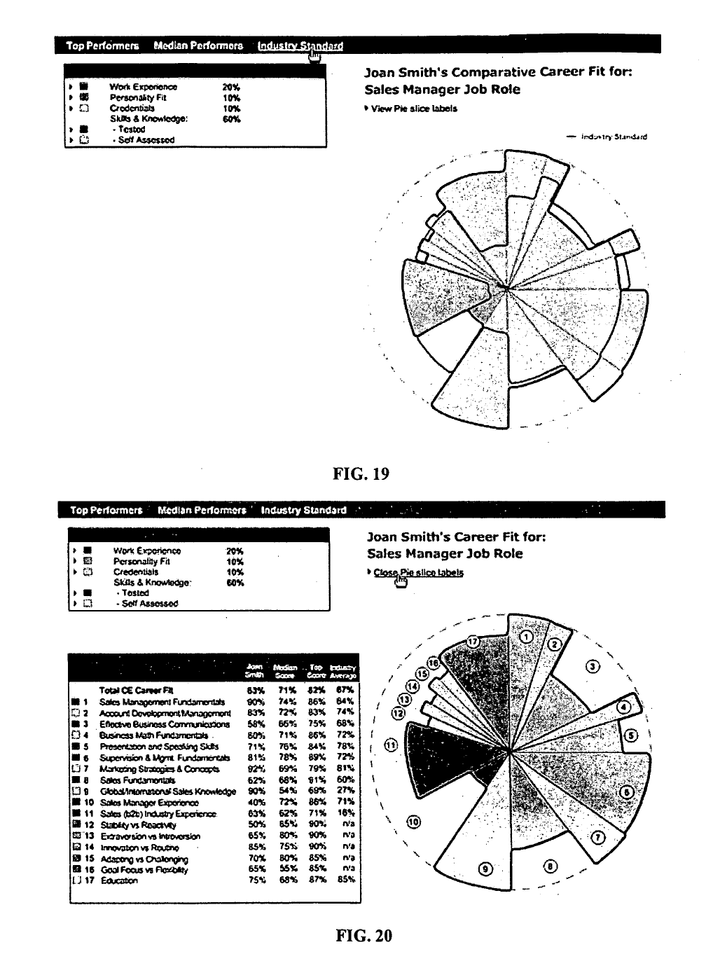

FIG. 19 illustrates how aggregating individual profiles of a large sample of candidates or employees for a specific job role (e.g., Sales Manager) enables the construction, using the method described herein, of an Industry Average job fit visualization which can be used as a comparison with which to gauge an individuals' overall proficiency and proficiencies in specific areas. Such comparisons are also possible to other aggregated standards. FIG. 19 shows how the top performers in an organization can be aggregated to produce a Top Performer's norm for comparison, as can be done with Median performers in an organization, or for that matter, any other aggregation of employee profiles which an organization wishes to use as a comparative standard.

Following on the above calculations, an individual job fit score can be calculated as a percentage of the total job requirement score or the total average performers score or top performers score. This can be accomplished by calculating both the individual's score for each wedge and the job requirement (or average/top performers) score for each wedge, then comparing the two scores. Where the individual's wedge score is equal to or greater than the job requirement score, the individual would receive 100% of the job requirement score. In cases where the individual's score is less than the job requirement score for a given wedge, the comparative wedge score can be found by dividing the individual's score by the job requirement score and multiplying by 100%. By summing each wedge's raw comparative score (i.e., not converted to a percentage) for the individual and then dividing by the total job requirement raw score and multiplying by 100%, the individual's fit score in relation to the job requirement (or average/top performers, etc.) can be found and displayed.

FIG. 20 shows how the graphical representation of an individual's job fit can be augmented by providing a detailed columnar breakdown for the individual of each attribute score by category compared to the various industry, top performers, and media performers average scores, all in relation to the job profile standard. Additionally, overall summarized job fit scores are shown which enables a quick numerical comparison between an individuals overall job fit and the average job fit scores of the various groups

FIG. 21 illustrates how, using interactive computer graphical programming, each wedge can also be rolled over to produce a pop-up box with a detailed description of the wedge, the individual's score for the specific wedge.

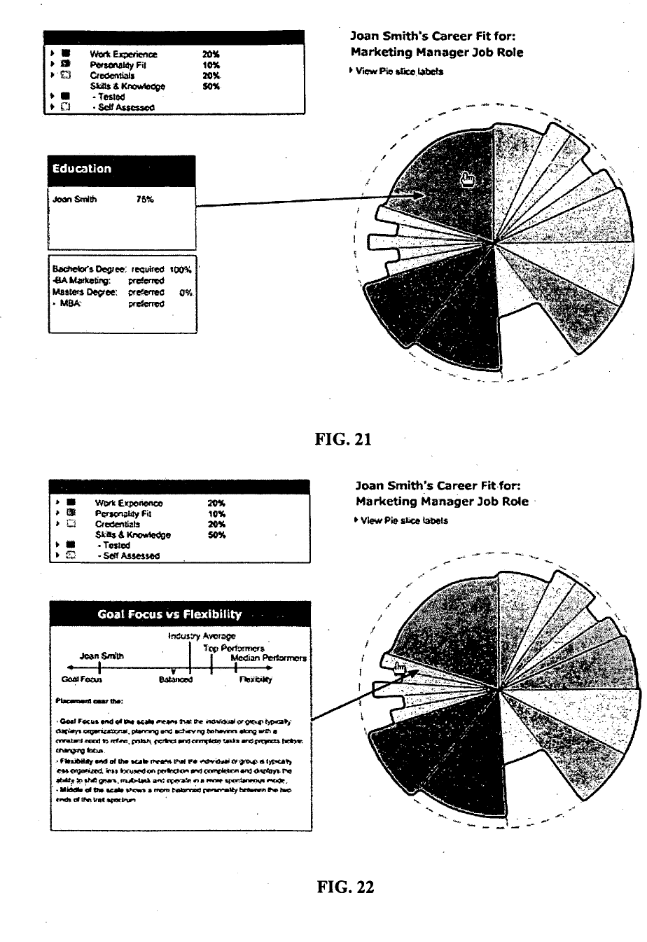

FIG. 22 shows how the Personality Traits rollovers can include a summarized explanation of each trait and depict the individual's score in relation to the group averages and job standard along the various trait continuums.

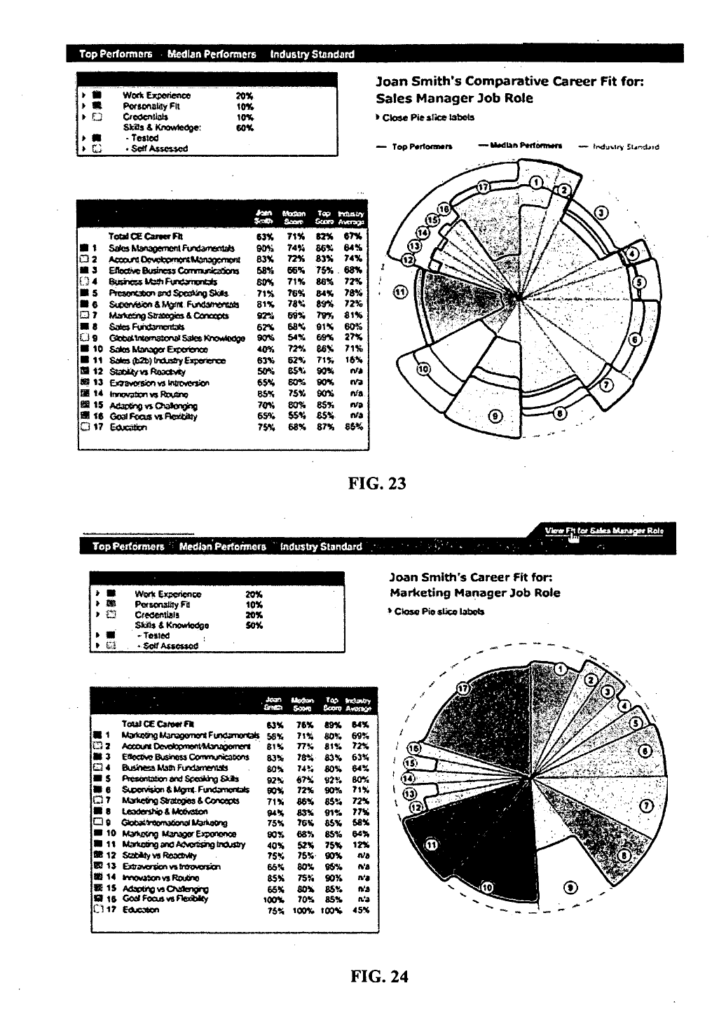

FIG. 23 illustrates how a comprehensive view of the visualization can be used to compare the overall and specific job fits visually between multiple groups or individuals at one time. In this view, each group visualization shape can be highlighted by a different bold color (for example, Black for job requirement; Green for industry average; Red for Top Performers; and Blue for Median Performers). This comprehensive comparative view enables quick and efficient identification of individual overall and specific proficiencies with direct reference to established norms.

FIG. 24 illustrates how the same multiple views discussed above can be quickly and easily applied to hundreds of different standard job roles or custom job orders. Using the method described hereinabove, one can simply browse for a different job role, and with the click of a mouse, pull the associated job profile data from the database, and initiate the rapid construction of an interactive job fit visualization to virtually any specific job role.

In so far as embodiments of the invention described herein are implemented, at least in part, using software controlled programmable processing devices, such as a computer system, it will be appreciated that one or more computer programs for configuring such programmable devices or system of devices to implement the foregoing described job fit visualization platform and program are to be considered an aspect of the present invention. The computer programs can be embodied as source code and undergo compilation for implementation on processing devices or a system of devices, or can be embodied as object code, for example. Those of ordinary skill in the art will readily understand that the term computer in its most general sense encompasses programmable devices such as those referred to above, and data processing apparatus, computer systems and the like. Preferably, the computer programs are stored on carrier media in machine or device readable form, for example in solid-state memory or magnetic memory such as disk or tape, and processing devices utilize the programs or parts thereof to configure themselves for operation.

It should be appreciated that the aspects, features and advantages made apparent from the foregoing and the accompanying drawings are efficiently attained and, since certain changes may be made in the disclosed constructions and processes without departing from the spirit and scope of the invention, it is intended that all matter contained herein and in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method for providing a visual representation of a comparative fit of an individual's employment attributes to job requirements, the method comprising the steps of:
obtaining data concerning employment attributes of an individual;
storing said employment attribute data in a database;
creating at least one job profile exemplifying requirements of job roles;
storing said at least one job profile in said database;
comparing said employment attribute data against said job role requirements of said at least one job profile; and
generating a visual representation of said individual's employment attributes in quantifiable proportion to at least one job role requirement of said at least one job profile.

2. The method according to claim 1, wherein said step of obtaining data concerning employment attributes of said individual includes obtaining data concerning at least one of said individual's educational background, work experience, professional credentials, achievements, skills, knowledge and personality traits.

3. The method according to claim 1, wherein said step of obtaining data concerning employment attributes of said individual includes soliciting responses to a questionnaire.

4. The method according to claim 3, wherein said questionnaire is an electronic form, and said questionnaire includes at least one preselected questionnaire response.

5. The method according to claim 4, wherein said at least one preselected questionnaire response includes a rating of a set of ratings.

6. The method according to claim 5, wherein at least one response to said at least one preselected questionnaire response is convertible into a percentage score.

7. The method according to claim 4, wherein said questionnaire is provided via a computer network.

8. The method according to claim 7, wherein said computer network is the Internet.

9. The method according to claim 1, further comprising the step of validating ones of said employment attribute data which are at least one of related to jobs of particular interest to said individual and indicative of a high proficiency level.

10. The method according to claim 9, wherein said step of validating ones of said employment attribute data includes completing at least one certification test.

11. The method according to claim 10, wherein said at least one certification test is at least one of a computer adaptive testing skill test and a computer administered personality test.

12. The method according to claim 9, further comprising the step of effecting third-party validation of non-testable ones of said employment attribute data.

13. The method according to claim 1, wherein said step of creating at least one job profile exemplifying requirements of job roles includes selecting ones of said requirements from a menu of said requirements.

14. The method according to claim 13, wherein said menu is an electronic form, and said menu includes at least one preselected menu response.

15. The method according to claim 14, wherein said at least one preselected menu response includes a score of a set of scores.

16. The method according to claim 15, wherein at least one response to said at least one preselected menu response is convertible into a percentage score.

17. The method according to claim 14, wherein said menu is provided via a computer network.

18. The method according to claim 17, wherein said computer network is the Internet.

19. The method according to claim 1, wherein said visual representation is displayed in the form of an image including outwardly radiating wedge sections of at least one of different dimensions and colors arranged in an annular geometry.

20. The method according to claim 1, wherein said job role requirements include requirements for skills, knowledge, educational and professional credentials, personality traits, experience and job levels.

21. The method according to claim 20, wherein said job role requirements are requirements obtained from at least one of labor market data and research data from employment specialists.

22. The method according to claim 20, further comprising the step of assigning relative weightings to said job role requirements.

23. The method according to claim 22, wherein said visual representation is displayed in the form of an image including outwardly radiating wedge sections of at least one of different dimensions and colors arranged in an annular geometry, said relative weightings defining the size of said wedge sections.

24. The method according to claim 1, further comprising the step of selecting ones of said job role requirements and assigning a job requirement score and a maximal attainment score to each of said key requirements.

25. The method according to claim 24, wherein said visual representation is displayed in the form of an image including outwardly radiating wedge sections of at least one of different dimensions and colors arranged in an annular geometry, said job requirement score and said maximal attainment score defining a perimeter of said annular geometry.

26. The method according to claim 1, wherein said step of obtaining data concerning employment attributes of an individual involves obtaining said employment attribute data from a source other than said individual.

27. The method according to claim 1, further comprising the step of modifying requirements of said at least one job profile to create at least one custom job profile based on non-standard job requirements, and storing said at least one custom job profile in said database.

28. The method according to claim 27, wherein said step of modifying requirements of said at least one job profile to create at least one custom job profile includes at least one of modifying relative weightings assigned to said job role requirements, adding new job role requirements and deleting job role requirements.

29. The method according to claim 27, further comprising the steps of comparing said employment attribute data against said requirements of said at least one custom job profile, and generating a visual representation of said individual's employment attributes in quantifiable proportion to at least one job requirement of said at least one custom job profile.

30. The method according to claim 29, wherein said visual representation is displayed in the form of an image including outwardly radiating wedge sections of at least one of different dimensions and colors arranged in an annular geometry.

31. The method according to claim 1, wherein said step of obtaining data concerning employment attributes of an individual includes obtaining data concerning employment attributes of a plurality of individuals, and further comprising the steps of calculating a group average for said employment attributes for comparison against said at least one job role requirement of said at least one job profile.

32. The method according to claim 1, wherein said step of obtaining data concerning employment attributes of an individual includes obtaining data concerning employment attributes of a plurality of individuals, and further comprising the steps of calculating a group average for said employment attributes for comparison against employment attribute data of a particular one of said individuals.

33. The method according to claim 1, further comprising the step of navigating through said visual representation to obtain detailed data and comparisons by at least one of qualification category and job attribute.

34. The method according to claim 1, further comprising the step of determining at least one best fit/highest scoring fit job role for said individual based on said comparison of said employment attribute data against said at least one job profile.

35. The method according to claim 1, further comprising the step of determining at least one best fit/highest scoring fit individual for said at least one job profile based on said comparison of said employment attribute data against said at least one job profile.

36. The method according to claim 1, further comprising the steps of providing a database of employment-related training programs, and generating at least one recommendation of at least one of said training programs based on at least one of a skill and knowledge gap between said employment attribute data and said job role requirements.

37. A method for providing a visual representation of job requirements, the method comprising the steps of:
obtaining data concerning requirements of job roles;
creating at least one job profile exemplifying said requirements of job roles;
storing said at least one job profile in said database; and
generating a visual representation of said job role requirements for particular job roles, said visual representation being displayed in the form of an image including outwardly radiating wedge sections of at least one of different dimensions and colors arranged in an annular geometry.

38. The method according to claim 37, wherein said job role requirements include requirements for skills, knowledge, educational and professional credentials, personality traits, experience and job levels.

39. The method according to claim 38, wherein said job role requirements are requirements obtained from at least one of labor market data and research data from employment specialists.

40. The method according to claim 37, further comprising the step of assigning relative weightings to said job role requirements, said relative weightings defining the size of said wedge sections of said visual representation.

41. A system for providing a visual representation of a comparative fit of an individual's employment attributes to job requirements, comprising:
means for obtaining data concerning employment attributes of an individual;
means for creating at least one job profile exemplifying requirements of job roles;
a database for storing said employment attribute data and said at least one job profile;
means for comparing said employment attribute data against said job role requirements of said at least one job profile; and
means for generating a visual representation of said individual's employment attributes in quantifiable proportion to at least one job role requirement of said at least one job profile.

42. The system according to claim 41, wherein said employment attributes of said individual include at least one of said individual's educational background, work experience, professional credentials, achievements, skills, knowledge and personality traits.

43. The system according to claim 41, wherein said means for obtaining data concerning employment attributes of said individual is a questionnaire.

44. The system according to claim 43, wherein said questionnaire is an electronic form including at least one preselected questionnaire response.

45. The system according to claim 44, wherein said at least one preselected questionnaire response includes a rating of a set of ratings.

46. The system according to claim 45, wherein at least one response to said at least one preselected questionnaire response is convertible into a percentage score.

47. The system according to claim 44, wherein said questionnaire is provided via a computer network.

48. The system according to claim 47, wherein said computer network is the Internet.

49. The system according to claim 41, further comprising means for validating ones of said employment attribute data which are at least one of related to jobs of particular interest to said individual and indicative of a high proficiency level.

50. The system according to claim 49, wherein said means for validating ones of said employment attribute data includes at least one certification test.

51. The system according to claim 50, wherein said at least one certification test is at least one of a computer adaptive testing skill test and a computer administered personality test.

52. The system according to claim 49, further comprising means for effecting third-party validation of non-testable ones of said employment attribute data.

53. The system according to claim 41, wherein said means for creating at least one job profile exemplifying requirements of job roles includes means for selecting ones of said requirements from a menu of said requirements.

54. The system according to claim 53, wherein said menu is an electronic form, and said menu includes at least one preselected menu response.

55. The system according to claim 54, wherein said at least one preselected menu response includes a score of a set of scores.

56. The system according to claim 55, wherein at least one response to said at least one preselected menu response is convertible into a percentage score.

57. The system according to claim 54, wherein said menu is provided via a computer network.

58. The system according to claim 57, wherein said computer network is the Internet.

59. The system according to claim 41, wherein said visual representation is displayed in the form of an image including outwardly radiating wedge sections of at least one of different dimensions and colors arranged in an annular geometry.

60. The system according to claim 41, wherein said job role requirements include requirements for skills, knowledge, educational and professional credentials, personality traits, experience and job levels.

61. The system according to claim 60, wherein said job role requirements are requirements obtained from at least one of labor market data and research data from employment specialists.

62. The system according to claim 60, further comprising means for assigning relative weightings to said job role requirements.

63. The system according to claim 62, wherein said visual representation is displayed in the form of an image including outwardly radiating wedge sections of at least one of different dimensions and colors arranged in an annular geometry, said relative weightings defining the size of said wedge sections.

64. The system according to claim 41, further comprising means for selecting ones of said job role requirements and assigning a job requirement score and a maximal attainment score to each of said key requirements.

65. The system according to claim 64, wherein said visual representation is displayed in the form of an image including outwardly radiating wedge sections of at least one of different dimensions and colors arranged in an annular geometry, said job requirement score and said maximal attainment score defining a perimeter of said annular geometry.

66. The system according to claim 41, further comprising means for modifying requirements of said at least one job profile to create at least one custom job profile based on non-standard job requirements.

67. The system according to claim 66, wherein said means for modifying requirements of said at least one job profile to create at least one custom job profile are adapted to permit modification of relative weightings assigned to said job role requirements, the addition of new job role requirements and the deletion of job role requirements.

68. The system according to claim 66, further comprising means for comparing said employment attribute data against said requirements of said at least one custom job profile, and for generating a visual representation of said individual's employment attributes in quantifiable proportion to at least one job requirement of said at least one custom job profile.

69. The system according to claim 68, wherein said visual representation is displayed in the form of an image including outwardly radiating wedge sections of at least one of different dimensions and colors arranged in an annular geometry.

70. The system according to claim 41, wherein said means for obtaining data concerning employment attributes of an individual includes means for obtaining data concerning employment attributes of a plurality of individuals, and further comprising means for calculating a group average for said employment attributes for comparison against said at least one job role requirement of said at least one job profile.

71. The system according to claim 41, wherein said means for obtaining data concerning employment attributes of an individual includes means for obtaining data concerning employment attributes of a plurality of individuals, and further comprising means for calculating a group average for said employment attributes for comparison against employment attribute data of a particular one of said individuals.

72. The system according to claim 41, further comprising means for navigating through said visual representation to obtain detailed data and comparisons by at least one of qualification category and job attribute.

73. The system according to claim 41, further comprising means for determining at least one best fit/highest scoring fit job role for said individual based on said comparison of said employment attribute data against said at least one job profile.

74. The system according to claim 41, further comprising means for determining at least one best fit/highest scoring fit individual for said at least one job profile based on said comparison of said employment attribute data against said at least one job profile.

75. The system according to claim 41, further comprising a database of employment-related training programs, and means for generating at least one recommendation of at least one of said training programs based on at least one of a skill and knowledge gap between said employment attribute data and said job role requirements.

76. A system for providing a visual representation of job requirements, comprising:
means for obtaining data concerning requirements of job roles;
means for creating at least one job profile exemplifying said requirements of job roles;
a database for storing said at least one job profile; and
means for generating a visual representation of said job role requirements for particular job roles, said visual representation being displayed in the form of an image including outwardly radiating wedge sections of at least one of different dimensions and colors arranged in an annular geometry.

77. The system according to claim 76, wherein said job role requirements include requirements for skills, knowledge, educational and professional credentials, personality traits, experience and job levels.

78. The system according to claim 77, wherein said job role requirements are requirements obtained from at least one of labor market data and research data from employment specialists.

79. The system according to claim 76, further comprising means for assigning relative weightings to said job role requirements, said relative weightings defining the size of said wedge sections of said visual representation.

80. A computer program product comprising a computer usable medium having a computer readable program code means embodied in said medium for causing an application program to execute on a computer for providing a visual representation of the comparative fit of an individual's employment attributes to job requirements, said computer readable program code means including:
means for obtaining data concerning employment attributes of an individual;
means for storing said employment attribute data in a database;
means for creating at least one job profile exemplifying requirements of job roles;
means for storing said at least one job profile in said database;
means for comparing said employment attribute data against said job role requirements of said at least one job profile; and
means for generating a visual representation of said individual's employment attributes in quantifiable proportion to at least one job role requirement of said at least one job profile.

81. The computer program product according to claim 80, wherein said employment attributes of said individual include at least one of said individual's educational background, work experience, professional credentials, achievements, skills, knowledge and personality traits.

82. The computer program product according to claim 80, wherein said means for obtaining data concerning employment attributes of said individual is a questionnaire.

83. The computer program product according to claim 82, wherein said questionnaire includes at least one preselected questionnaire response.

84. The computer program product according to claim 83, wherein said at least one preselected questionnaire response includes a rating of a set of ratings.

85. The computer program product according to claim 84, wherein at least one response to said at least one preselected questionnaire response is convertible into a percentage score.

86. The computer program product according to claim 80, further comprising means for validating ones of said employment attribute data which are at least one of related to jobs of particular interest to said individual and indicative of a high proficiency level.

87. The computer program product according to claim 86, wherein said means for validating ones of said employment attribute data includes means for effecting at least one certification test.

88. The computer program product according to claim 87, wherein said at least one certification test is at least one of a computer adaptive testing skill test and a computer administered personality test.

89. The computer program product according to claim 87, further comprising means for effecting third-party validation of non-testable ones of said employment attribute data.

90. The computer program product according to claim 80, wherein said means for creating at least one job profile exemplifying requirements of job roles includes means for selecting ones of said requirements from a menu of said requirements.

91. The computer program product according to claim 90, wherein said menu includes at least one preselected menu response.

92. The computer program product according to claim 91, wherein said at least one preselected menu response includes a score of a set of scores.

93. The computer program product according to claim 92, wherein at least one response to said at least one preselected menu response is convertible into a percentage score.

94. The computer program product according to claim 80, wherein said visual representation is displayed in the form of an image including outwardly radiating wedge sections of at least one of different dimensions and colors arranged in an annular geometry.

95. The computer program product according to claim 80, wherein said job role requirements include requirements for skills, knowledge, educational and professional credentials, personality traits, experience and job levels.

96. The computer program product according to claim 95, wherein said job role requirements are requirements obtained from at least one of labor market data and research data from employment specialists.

97. The computer program product according to claim 95, further comprising means for assigning relative weightings to said job role requirements.

98. The computer program product according to claim 97, wherein said visual representation is displayed in the form of an image including outwardly radiating wedge sections of at least one of different dimensions and colors arranged in an annular geometry, said relative weightings defining the size of said wedge sections.

99. The computer program product according to claim 80, further comprising means for selecting ones of said job role requirements and assigning a job requirement score and a maximal attainment score to each of said key requirements.

100. The computer program product according to claim 99, wherein said visual representation is displayed in the form of an image including outwardly radiating wedge sections of at least one of different dimensions and colors arranged in an annular geometry, said job requirement score and said maximal attainment score defining a perimeter of said annular geometry.

101. The computer program product according to claim 80, further comprising means for modifying requirements of said at least one job profile to create at least one custom job profile based on non-standard job requirements.

102. The computer program product according to claim 101, wherein said means for modifying requirements of said at least one job profile to create at least one custom job profile are adapted to permit modification of relative weightings assigned to said job role requirements, the addition of new job role requirements and the deletion of job role requirements.

103. The computer program product according to claim 101, further comprising means for comparing said employment attribute data against said requirements of said at least one custom job profile, and for generating a visual representation of said individual's employment attributes in quantifiable proportion to at least one job requirement of said at least one custom job profile.

104. The computer program product according to claim 103, wherein said visual representation is displayed in the form of an image including outwardly radiating wedge sections of at least one of different dimensions and colors arranged in an annular geometry.

105. The computer program product according to claim 80, wherein said means for obtaining data concerning employment attributes of an individual includes means for obtaining data concerning employment attributes of a plurality of individuals, and further comprising means for calculating a group average for said employment attributes for comparison against said at least one job role requirement of said at least one job profile.

106. The computer program product according to claim 80, wherein said means for obtaining data concerning employment attributes of an individual includes means for obtaining data concerning employment attributes of a plurality of individuals, and further comprising means for calculating a group average for said employment attributes for comparison against employment attribute data of a particular one of said individuals.

107. The computer program product according to claim 80, further comprising means for effecting navigation through said visual representation to obtain detailed data and comparisons by at least one of qualification category and job attribute.

108. The computer program product according to claim 80, further comprising means for determining at least one best fit/highest scoring fit job role for said individual based on said comparison of said employment attribute data against said at least one job profile.

109. The computer program product according to claim 80, further comprising means for determining at least one best fit/highest scoring fit individual for said at least one job profile based on said comparison of said employment attribute data against said at least one job profile.

110. The computer program product according to claim 80, further means for providing access to a source of data concerning employment-related training programs, and means for generating at least one recommendation of at least one of said training programs based on at least one of a skill and knowledge gap between said employment attribute data and said job role requirements.

111. A computer program product comprising a computer usable medium having a computer readable program code means embodied in said medium for causing an application program to execute on a computer for providing a visual representation of job requirements, said computer readable program code means including:
means for obtaining data concerning requirements of job roles;
means for creating at least one job profile exemplifying said requirements of job roles;
means for storing said at least one job profile in a database; and
means for generating a visual representation of said job role requirements for particular job roles, said visual representation being displayed in the form of an image including outwardly radiating wedge sections of at least one of different dimensions and colors arranged in an annular geometry.

112. The computer program product according to claim 111, wherein said job role requirements include requirements for skills, knowledge, educational and professional credentials, personality traits, experience and job levels.

113. The computer program product according to claim 112, wherein said job role requirements are requirements obtained from at least one of labor market data and research data from employment specialists.

114. The computer program product according to claim 111, further comprising means for assigning relative weightings to said job role requirements, said relative weightings defining the size of said wedge sections of said visual representation.
